(19) United States
(12) Patent Application Publication
(10) Pub. No.: US 2026/0070516 A1
(43) Pub. Date: Mar. 12, 2026

(54) ADAPTER ASSEMBLY FOR A VEHICLE WIPER SYSTEM

(71) Applicant: VALEO SYSTEMES D'ESSUYAGE, La Verriere (FR)

(72) Inventors: Thomas CAETANO, La Verriere (FR); Stephane HOUSSAT, La Verriere (FR); Vincent GAUCHER, La Verriere (FR)

(73) Assignee: VALEO SYSTEMES D'ESSUYAGE, La Verriere (FR)

(21) Appl. No.: 18/828,065

(22) Filed: Sep. 9, 2024

(51) Int. Cl. B60S 1/40

(52) U.S. Cl. CPC B60S 1/4019; B60S 2001/4093

(57) ABSTRACT

The present invention relates to an adapter assembly for a vehicle wiper system. The adapter assembly includes a base member, a tilting member, a locking cap and a spacer. The base member is pivotally mounted on a connector of a wiper blade, and the tilting member is pivotally mounted at rear end of the base member. The spacer is mounted on the tilting member allowing connection of wiper arms with different designs with the adapter assembly. The spacer includes a flexible tab provided near lower face, which deforms while sliding the wiper arm on the spacer for engagement. When the wiper arm is completely slid over the spacer, the flexible tab comes back to neutral state to cooperate with folded edges of the wiper arm and restricts rearward movement of the arm with respect to the spacer.

### TECHNICAL FIELD

The present invention relates to a windscreen wiper system for a motor vehicle, and more particularly to an adapter assembly for connecting a windscreen wiper blade to an arm of a wiper system.

Generally, a motor vehicle includes a windshield provided in the front of the vehicle to provide proper visibility to the diver and at the same time to separate the vehicle interior space from outside. The windshield also protects the occupants from elements like wind, rain and likewise. However, accumulation of water, dirt, dust etc. on the windshield obstructs the vision of the driver and may become cause of fatal accident. Therefore, a wiper system is provided to wipe out any dirt and water from the windshield. Similarly, the wiper systems may be provided for rear windshield as well as for the door windows, as per the requirement.

### BACKGROUND OF THE INVENTION

The wiper system traditionally consists of a wiper arm, one end of which is connected to an output shaft of a wiper motor through linkages and a wiper blade is attached to another end of the wiper arm. The wiper motor drives the wiper arm to swing between the predefined angular positions to wipe out the water and dirt present on the windshield.

Each wiper blade comprises a structure supporting a wiper rubber intended to be placed in contact with the windscreen so that it can remove water and/or dirt from the windscreen panel. Additionally, each wiper blade comprises a connector rigidly connected to the structure of the wiper blade and an adapter assembly mounted pivotally on the connector in order to allow the detachable fastening of the wiper arm of the wiper system to the adapter assembly.

In a known manner, a yoke/clevis is formed at the end of the wiper arm and the yoke/clevis is engaged with the adapter assembly and locked therein. There are variety of wiper arms having different designs of the yoke, being used in different motor vehicles. This requires motor vehicle manufacturers to design adapter assembly specific to each type of wiper arm, an adapter assembly specifically making the link between a type of wiper arm and a connector. So, the equipment manufacturers needs to develop many different adapters, including at least one for each type of wiper arm on the market. Further, the users who need to change their wiper blade, needs to adapt and take extra care to choose the right adapter assembly for the type of wiper arm on which the wiper blade is to be mounted. This creates lot of inconvenience to the user while changing the wiper blades.

### SUMMARY OF THE INVENTION

An object of the present invention is to solve the disadvantages described above of known adapter assembly(s). In particular, an object of the present invention is to provide an adapter assembly compatible with multiple wiper arms.

Another object of the present invention is to provide a spacer for an adapter assembly to make the adapter assembly compatible with different types of wiper arms having different yoke designs.

Yet another object of the present invention is to provide a spacer for an adapter assembly compatible with wiper arm having yoke with longitudinal folded edges.

In this context, the present invention is directed towards a spacer for an adapter assembly of a wiper system. The spacer includes a first longitudinal wall and a second longitudinal wall spaced apart from the first longitudinal wall. The first longitudinal wall and the second longitudinal wall may be connected to each other by an upper wall. A flexible tab may be formed near a lower face of at least one of the first longitudinal wall and the second longitudinal wall. The flexible tab may include at least a deformable portion. The flexible tab may be formed on the first longitudinal wall or on the second longitudinal wall or on both the longitudinal walls of the spacer. Moreover, the flexible tab may be integrally formed with the corresponding longitudinal wall(s) of the spacer. Preferably, the flexible tab may be located in longitudinally central region of the spacer.

In a non-limiting embodiment of the present invention, the flexible tab may include a fixed portion protruding outwards from at least one of the first longitudinal wall and the second longitudinal wall. The fixed portion may extend longitudinally along the lower face of the first and/or the second longitudinal wall, to a predefined length.

In a non-limiting embodiment of the present invention, the deformable portion may longitudinally extend from the fixed portion, the deformable portion being inclined away from the upper wall, in neutral state. The deformable portion may be configured to deform towards the upper wall. The deformable portion may be integrally formed with the fixed portion and may be intended to deform upwards in a plane parallel to the plane of the corresponding longitudinal wall.

In a non-limiting embodiment of the present invention, a bearing tab may be formed near the lower face of at least one of the first longitudinal wall and the second longitudinal wall. On the longitudinal wall having the flexible tab, the bearing tab may be provided longitudinally in front of the flexible tab. More preferably, the fixed portion of the flexible tab and the bearing tab may be longitudinally aligned. In case the flexible tab is provided only on one of the longitudinal walls, one bearing tab may be provided in front of the flexible tab and another bearing tab may be provided on another longitudinal wall.

In a non-limiting embodiment of the present invention, a stopper may be formed near at least one of a first longitudinal end of the first longitudinal wall and a second longitudinal end of the second longitudinal wall. Preferably, stopper may be provided on both the longitudinal walls. The stoppers may be provided near lower face of the longitudinal walls and may extend outwards from outer surfaces of the longitudinal walls. These stoppers may be adapted to restrict longitudinally forward movement of a wiper arm when the wiper arm is mounted on the spacer.

In a non-limiting embodiment of the present invention, a securing means may be provided including a locking tab formed on an inner surface of at least one of the first longitudinal wall and the second longitudinal wall, and a hook projecting from the upper wall. The locking tab may be provided on each of the first and second longitudinal walls. Preferably, the locking tabs and the hook may be adapted to cooperate with a tilting member of the adapter assembly to secure the spacer on the tilting member. It is to be understood that the locking tabs and the hook may be adapted to cooperate with any other suitable component of the adapter assembly to secure the spacer on that component.

In a non-limiting embodiment of the present invention, the flexible tab may include a tooth formed on an abutting face of the deformable portion. The abutting face may be defined at free end of the deformable portion of the flexible tab. Further, the tooth may extend in longitudinally forward direction from the abutting face. When the wiper arm is mounted on the spacer, the abutting face cooperates with folded edges of the wiper arm to restrict rearward movement of the wiper arm with respect to the spacer. Further, the tooth cooperates with the folded edges to prevent deformation of the deformable portion in downward direction i.e. in direction away from the upper wall.

In a non-limiting embodiment of the present invention, at least one stud may be formed on the upper wall. The stud(s) may be provided at predefined location(s) on the upper wall and may extend in upward direction to a predefined height. The stud(s) may be adapted to support a top wall of the wiper arm.

The present invention also relates to an adapter assembly for a wiper system. The adapter assembly may include a base member, a tilting member, a locking cap, and a spacer. The base member may have a front end and a rear end. The tilting member may be pivotally connected to the rear end of the base member. The locking cap may be pivotally connected to the front end of the base member. The spacer may be adapted to be removably secured to the tilting member. The spacer may include two longitudinal walls spaced apart from each other and connected to each other by an upper wall. The spacer may further include a flexible tab formed near a lower face of at least one of the longitudinal walls. The flexible tab may include at least a deformable portion. The flexible tab may be formed on any one or both the longitudinal walls of the spacer. Moreover, the flexible tab may be integrally formed with the corresponding longitudinal wall(s) of the spacer. Preferably, the flexible tab(s) may be located in longitudinally central region of the spacer.

In a non-limiting embodiment of the present invention, the base member may be configured to be pivotally connected to a connector of a wiper blade. The base member may be positioned towards upper side of the connector, and lower side of the connector may be fixed to a structure of the wiper blade.

In a non-limiting embodiment of the present invention, the tilting member may include two side walls connected to each other by a top wall. The tilting member may have a front end and a rear end. The rear end of the tilting member may be pivotally connected to the rear end of the base member. This pivotal connection allows the front end of the tilting member to be raised away from the base member while attaching certain types of wiper arms, especially the wiper arms having folded edges design.

In a non-limiting embodiment of the present invention, the spacer may be snap-fitted over the tilting member, the upper wall of the spacer being positioned above the top wall of the tilting member and the longitudinal walls of the spacer being positioned juxtaposed to the side walls of the tilting member. The spacer makes it possible to make the adapter assembly compatible with the wiper arm designs that cannot be directly mounted on the tilting member.

In a non-limiting embodiment of the present invention, the spacer may further include a securing means to secure the spacer to the tilting member. It is to be understood that the securing means may be adapted to sure the spacer to any other suitable component of the adapter assembly.

In a non-limiting embodiment of the present invention, the securing means may include a locking tab formed on an inner surface of at least one of the longitudinal walls, and a hook projecting from the upper wall of the spacer. The locking tab may be provided on each of the longitudinal walls. The locking tabs and the hook may be adapted to cooperate with a tilting member of the adapter assembly to secure the spacer on the tilting member.

In a non-limiting embodiment of the present invention, the flexible tab may include a fixed portion protruding outwards from at least one of the longitudinal walls. The fixed portion may extend longitudinally along the lower face of the corresponding second longitudinal wall(s), to a predefined length.

In a non-limiting embodiment of the present invention, the deformable portion may longitudinally extend from the fixed portion. The deformable portion may be inclined away from the upper wall, in neutral state. The deformable portion may be adapted to deform towards the upper wall. The deformable portion may be integrally formed with the fixed portion and may be intended to deform upwards in a plane parallel to the plane of the corresponding longitudinal wall.

In a non-limiting embodiment of the present invention, the flexible tab may include an abutting face at a free end of the deformable portion. The abutting face may be adapted to cooperate with folded edges of the wiper arm. When the wiper arm is mounted on the spacer, the abutting face cooperates with corresponding folded edge of the wiper arm, to restrict rearward movement of the wiper arm with respect to the spacer.

In a non-limiting embodiment of the present invention, the flexible tab includes a tooth formed on the abutting face, the tooth configured to cooperate with the folded edge of the wiper arm to restrict the deformation of the deformable portion in a direction away from the upper wall i.e. downward direction.

In a non-limiting embodiment of the present invention, the spacer may further include at least one stud formed on the upper wall. The stud(s) may be provided at predefined location(s) on the upper wall and may extend in upward direction to a predefined height. The stud(s) may be adapted to support a top wall of the wiper arm.

The present invention also relates to a wiper system for a motor vehicle. The wiper system may include a connector, an adapter assembly, and a wiper arm. The connector may be adapted to be attached to a wiper blade. The wiper blade may include a wiper rubber attached to a structure, and the connector may be attached to the structure. The adapter assembly may be adapted to be pivotally connected to the connector. The wiper arm may be adapted to be releasably connected and secured to the adapter assembly. The wiper arm may include a yoke having folded edges, adapted to slide over the adapter assembly. The adapter assembly may include a spacer having two longitudinal walls spaced apart from each other and connected to each other by an upper wall, and a flexible tab formed near a lower face of at least one of the longitudinal walls. The flexible tab may include at least a deformable portion. The flexible tab allows the yoke of the wiper arm to slide over the spacer by deforming in a direction towards the upper wall. When the wiper arm is completely inserted over the spacer, the flexible tab regains neutral position and restricts longitudinally rearward movement of the wiper arm with respect to the spacer of the adapter assembly. For removing the wiper arm from the adapter assembly, the deformable portion of the flexible tab may be pushed upwards and the wiper arm may be slid rearwards.

### BRIEF DESCRIPTION OF DRAWINGS

The present invention is expounded in detail below with the aid of the presented drawings. Items shown in the drawings are not to scale and are simplified to increase clarity of disclosure. In the drawings:

FIGS. 1A and 1B illustrate schematic perspective views of a spacer, according to an embodiment of present invention;

FIG. 1C illustrates a schematic perspective view of the spacer from bottom side, according to an embodiment of present invention;

FIG. 1D illustrates a schematic top view of the spacer, according to an embodiment of present invention;

FIG. 1E illustrates a schematic side view of the spacer, according to an embodiment of present invention;

FIG. 2 illustrates a schematic side view of a spacer, according to an alternate embodiment of present invention;

FIGS. 3A, 3B, and 3C illustrate schematic top views of a spacer, according to alternate embodiments of present invention;

FIG. 4A illustrates a schematic perspective view of a connection of a wiper arm with a connector of wiper blade, according to an embodiment of present invention;

FIG. 4B illustrates an exploded view of the connection of FIG. 4A, according to an embodiment of present invention;

FIG. 4C illustrates mounting scheme of a base member on the connector, according to an embodiment of present invention;

FIGS. 4D and 4E illustrate mounting scheme of the components of the adapter assembly, according to an embodiment of present invention;

FIG. 5A illustrates a schematic perspective view of the spacer mounted on the tilting member, according to an embodiment of present invention;

FIG. 5B illustrates a schematic perspective view of the adapter assembly, according to an embodiment of present invention;

FIGS. 6A and 6B illustrate a schematic perspective view and front view of a wiper arm, respectively, according to an embodiment of present invention;

FIGS. 7A, 7B, 7C, and 7D illustrate the assembly steps for connecting the wiper arm to the adapter assembly, according to an embodiment of present invention;

FIGS. 8A and 8B illustrate insertion and locking of the wiper arm on the spacer, according to an embodiment of present invention; and

FIG. 8C illustrates zoomed view of the zone ‘Z’ of FIG. 8B, according to an embodiment of present invention.

### DETAILED DESCRIPTION OF THE INVENTION

The characteristics, variants and different modes of realization of the invention may be associated with each other in various combinations, in so far as they are not incompatible or exclusive with each other. In particular, variants of the invention comprising only a selection of features subsequently described in from the other features described may be imagined, if this selection of features is enough to confer a technical advantage and/or to differentiate the invention from prior art.

Items shown in the drawings are not to scale and are simplified to increase clarity of disclosure.

The following embodiments are examples. Although the description refers to one or more embodiments, this does not necessarily mean that each reference is to the same embodiment, or that the features apply only to one embodiment. Simple features of different embodiments may also be combined and/or interchanged to provide further embodiments.

In the present description, certain elements or parameters may be indexed, for example first element or second element as well as first parameter and second parameter or first criterion and second criterion, etc. In this case, it is a simple indexing operation to differentiate and name elements or parameters or criteria which are close, but not identical. In this case, simple indexing is used to differentiate and name elements or parameters or criteria which are close, but not identical. This indexing does not imply that one element, parameter or criterion has priority over another, and such names can easily be interchanged without going beyond the scope of this description. Nor does this indexing imply an order in time, for example to assess a particular criterion.

In the following detailed description, the terms ‘longitudinal’, ‘transverse’ and ‘vertical’ refer to the orientation of a wiper system according to the invention. A longitudinal direction corresponds to a main direction of elongation of a wiper blade of this wiper system, this longitudinal direction being parallel to a longitudinal axis L of a reference frame L, V, T illustrated in the figures. A vertical direction corresponds to a stacking direction of a connector, an adapter assembly and a wiper arm of the wiper system, this vertical direction being parallel to a vertical axis V of the reference frame L, V, T and this vertical axis V being perpendicular to the longitudinal axis L. Finally, a transverse direction corresponds to a direction parallel to a transverse axis T of the reference frame L, V, T, this transverse axis T being perpendicular to the longitudinal axis L and the vertical axis V being perpendicular to the longitudinal axis L.

In addition, the designations ‘lower’ and ‘upper’ with respect to the elements of the wiper system are understood with respect to the distance of these elements from the wiper blade, a lower end of such elements corresponding to the end disposed in the vicinity of this wiper blade, while an upper end corresponds to the end disposed at a distance from the wiper blade. The designations ‘front’, ‘forward’, ‘rear’ and ‘rearward’ needs to be understood with reference to the longitudinal direction L. Further, the designation ‘length’ refers to the dimension of the component/element measured along the longitudinal direction L. Moreover the designations ‘inner’ and ‘outer’ are understood with respect to the longitudinal central axis of the component. For example, the surface disposed towards the longitudinal central axis of the component may be referred as “inner surface” and the surface disposed away from the longitudinal central axis of the component may be referred as “outer surface”.

The present invention relates to a wiper system used to clean a glazed surface of a vehicle, for example a windscreen, so as to improve driver's visibility of the road in front of the vehicle. The wiper system generally comprises at least one wiper arm carrying at one end, a wiper blade which extends mainly along the longitudinal axis L. The wiper blade comprises at least one wiper strip (rubber), intended to be in contact with the glazed surface to be cleaned, and a support for the said wiper strip. The wiper blade is secured to the wiper arm by an adapter assembly. The adapter assembly according to the present invention includes a spacer to make the adapter assembly compatible with wiper arms of different types/designs. Particularly, the spacer includes a flexible tab that is adapted to deform for allowing wiper arm/yoke of the wiper arm to be inserted over the spacer. The flexible tab retracts to neutral position upon complete insertion of the yoke over the spacer and the flexible tab cooperates with the folded edges of the yoke to restrict longitudinally rearward movement of the yoke with respect to the spacer/adapter assembly. The spacer of present invention is also compatible with the wiper arms having folded edges longer than a predefined length, in that the flexible tab remains deformed after complete insertion of the yoke on the spacer and the rearward movement of the yoke may be restricted by a restricting feature present in the adapter assembly, more specifically by a restricting projection provided on a base member of the adapter assembly.

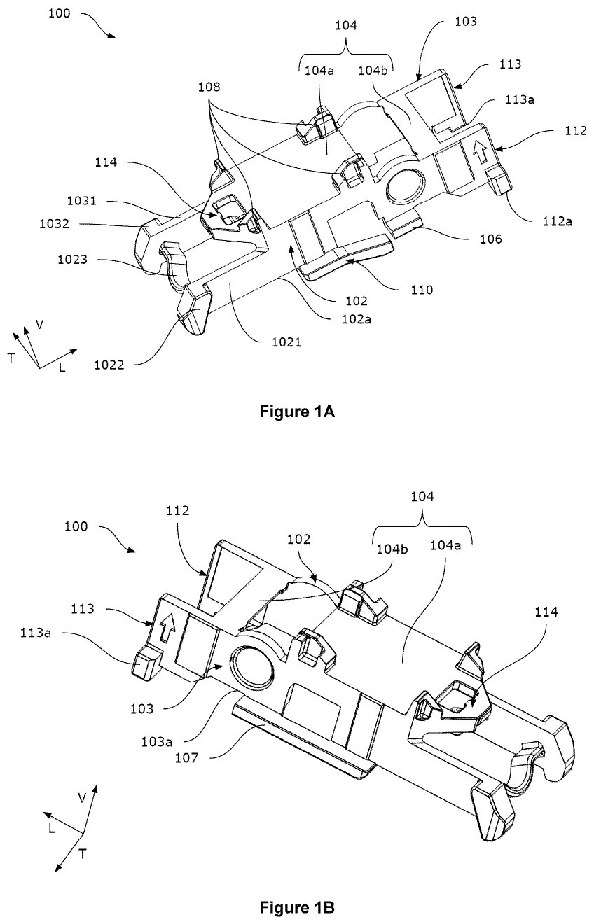

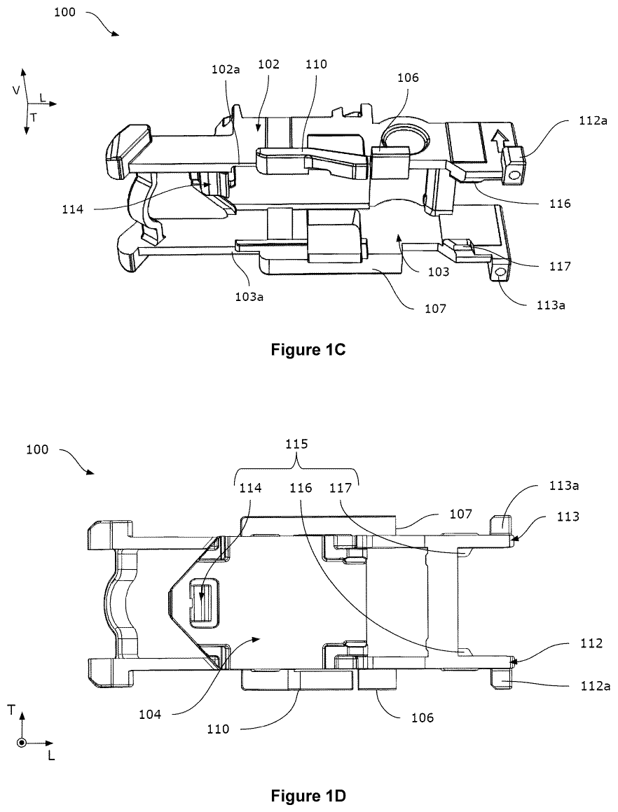

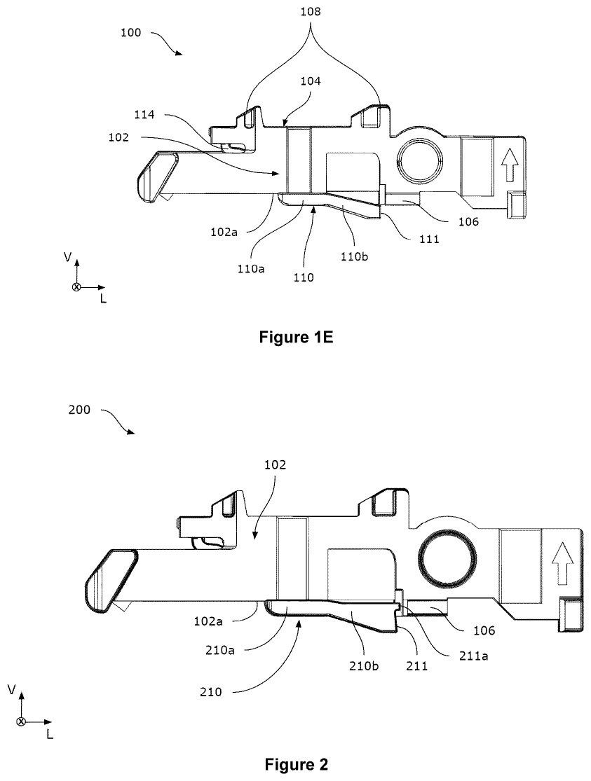

FIGS. 1A, 1B, 1C, 1D, and 1E illustrate different views of a spacer 100, according to a first embodiment of the present invention. The spacer 100 includes two longitudinal walls, a first longitudinal wall 102 and a second longitudinal wall 103. The first longitudinal wall 102 and the second longitudinal wall 103 are spaced apart from each other. Further, the first longitudinal wall 102 and the second longitudinal wall 103 are connected to each other by an upper wall 104. Preferably, the upper wall 104 may be integrally formed with the longitudinal walls 102, 103, and the upper wall 104 may extend between upper edges of the longitudinal walls 102, 103, as shown in FIGS. 1A and 1B. The upper wall 104 may extend at least partially along the length of the first longitudinal wall 102 and the second longitudinal wall 103. The upper wall 104 may include multiple portions separated longitudinally from each other. For example, FIGS. 1A and 1B shows two portions 104a, 104b of the upper wall 104 longitudinally spaced apart, making the spacer 100 compatible with certain types of wiper arms. The first longitudinal wall 102 may include a first longitudinal end 112 formed at a front end of the spacer 100, and a lower face 102a formed at an edge opposite to the upper wall 104. Similarly, the second longitudinal wall 103 may include a second longitudinal end 113 formed at the front end, and a lower face 103a formed at an edge opposite to the upper wall 104. A stopper 112a may be formed at the first longitudinal end 112, extending outward from an outer surface of the first longitudinal wall 102. Preferably, the stopper 112a may be formed near the lower face 102a of the first longitudinal wall 102. Similarly, another stopper 113a may be formed at the second longitudinal end 113, extending outward from an outer surface of the second longitudinal wall 103. Preferably, the stopper 113a may be formed near the lower face 103a of the second longitudinal wall 103.

As shown in FIGS. 1A, 1B and 1E, at least one stud 108 may be formed on the upper wall 104, extending upwards i.e. away from the first longitudinal wall 102 and/or the second longitudinal wall 103. Multiple studs 108 may be provided on the upper wall 104 at predefined locations and may extend to a predefined height from the upper wall 104. The studs 108 may have same or different heights, as per the design requirements, to make the spacer 100 compatible with different types/designs of wiper arm. As shown in FIGS. 1C and 1E, locking tabs 116, 117 may be formed on inner surfaces of the first longitudinal wall 102 and the second longitudinal wall 103, respectively. The locking tabs 116, 117 may be formed near the longitudinal ends 112. 113 of the longitudinal walls 102, 103, and preferably proximate to the lower faces 102a, 103a, respectively. The locking tabs 116, 117 may be formed on at least one of the first longitudinal wall 102 and the second longitudinal wall 103. Moreover, a hook 114 may be formed on the upper wall 104, projecting towards lower side of the upper wall 104, as shown in FIGS. 1C and 1E. The hook 114 along with the locking tabs 116, 117 forms a securing means 115, as indicated in FIG. 1D, to secure the spacer 100 to a tilting member of the adapter assembly.

As shown in FIGS. 1A, 1B, 1C, and 1D, bearing tabs 106, 107 may be formed near the lower faces 102a, 103a of the first longitudinal wall 102 and the second longitudinal wall 103, respectively. The bearing tab 106, 107 may be provided on at least one of the longitudinal walls 102, 103. In a particular embodiment as shown in FIG. 1A, one bearing tab 106 may be formed at the lower face 102a of the first longitudinal wall 102 and the bearing tab 106 may extend longitudinally to a predefined length along the lower face 102a. Similarly, as shown in FIG. 1B, another bearing tab 107 may be formed at the lower face 103a of the second longitudinal wall 103 and the bearing tab 107 may extend longitudinally to a predefined length along the lower face 103a. It can be noted that, length of the bearing tab 106 formed on the first longitudinal wall 102 may be less than the length of the bearing tab 107 formed on the second longitudinal wall 103.

As shown in FIGS. 1A, 1C and 1E, a flexible tab 110 may be formed at lower face 102a of the first longitudinal wall 102. The flexible tab 110 may be positioned adjacent to the bearing tab 106, preferably on rear side of the bearing tab 106. As indicated in FIG. 1E, the flexible tab 110 may include a fixed portion 110a protruding outwards from the first longitudinal wall 102 and a deformable portion 110b extending longitudinally from the fixed portion 110a. FIG. 1E shows neutral state i.e. un-deformed state of the deformable portion 110b. In neutral state, the deformable portion 110b may be inclined away from the upper wall 104 i.e. the deformable portion 110b may be tilted with respect to the fixed portion, in a plane parallel to the plane of the first longitudinal wall 102. The flexible tab 110 may include an abutting face 111 formed at free end of the deformable portion 110b. The deformable portion 110b may be adapted to deform towards the upper wall 104 thereby aligning the deformable portion 110b with the fixed portion 110a. Preferably, in deformed state of the deformable portion 110b, the flexible tab 110 and the bearing tab 106 may be aligned to form substantially continuous bearing means.

In a preferred embodiment, the length of the bearing tab 107 formed on the second longitudinal wall 103 may be substantially equal to the summation of lengths of the fixed portion 110a, deformable portion 110b, and the bearing tab 106.

In an alternate embodiment, the flexible tab 110 along with the bearing tab 106 may be formed on the second longitudinal wall 103, and the bearing tab 107 may be formed on the first longitudinal wall 102.

As shown in FIG. 1A, the spacer 100 may further include two tongues 1021, 1031 extending longitudinally rearwards from the first longitudinal wall 102 and the second longitudinal wall 103, respectively. Each of the tongues 1021, 1031 may have transversely projecting stops 1022, 1032, respectively at the end farthest from the front end. These tongues 1021, 1031 with their stops 1022, 1032 may be used in particular to fix and lock certain types of windscreen wiper arms. The spacer 100 may also include a cross-member 1023 connecting the rear ends of the tongues 1021, 1031, the cross-member 1023 being elastically deformable in compression. In particular, this cross-member 1023 stiffens the connection between the tongues 1021, 1031 locally and increases the force required to deform said tongues 1021, 1031 inwards. In particular, the cross-member 1023 may include at least one curved portion, as shown in FIG. 1A, in order to control its deformation. The tongues 1021, 1031 may be integrally formed with the first longitudinal wall 102 and the second longitudinal wall 103, and hence the tongues 1021. 1031 may form part of the first longitudinal wall 102 and the second longitudinal wall 103, respectively.

FIG. 2 shows a spacer 200 according to a second embodiment of the present invention. More specifically, the spacer 200 having a flexible tab 210 different from the flexible tab 110 of the first embodiment. The spacer 200 may have similar construction as the spacer 100 of the first embodiment, except the design of the flexible tabs 110, 210. The spacer 200 may include the flexible tab 210 formed at lower face 102a of the first longitudinal wall 102. The flexible tab 210 may be positioned adjacent to the bearing tab 106, preferably on rear side of the bearing tab 106, as shown in FIG. 2. Similar to the flexible tab 110 of the first embodiment, the flexible tab 210 of this embodiment may include a fixed portion 210a protruding outwards from the first longitudinal wall 102 and a deformable portion 210b extending longitudinally from the fixed portion 210a. An abutting face 211 may be formed at free end of the deformable portion 210b. Additionally, a tooth 211a may be formed on the abutting face 211, extending along longitudinal axis L. Preferably, the tooth 211a may be provided near upper edge of the abutting face 211, as shown in FIG. 2. It is to be noted that all other constructional features of the spacer 200 may be similar to the spacer 100 as disclosed in the first embodiment.

In an alternate embodiment, the flexible tab 210 along with the bearing tab 106 may be formed on the second longitudinal wall 103, and the bearing tab 107 may be formed on the first longitudinal wall 102.

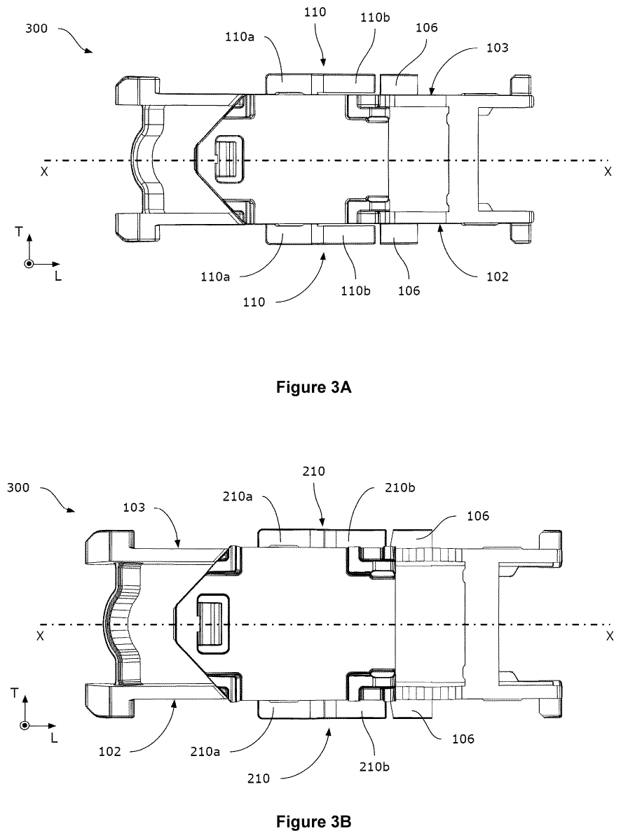

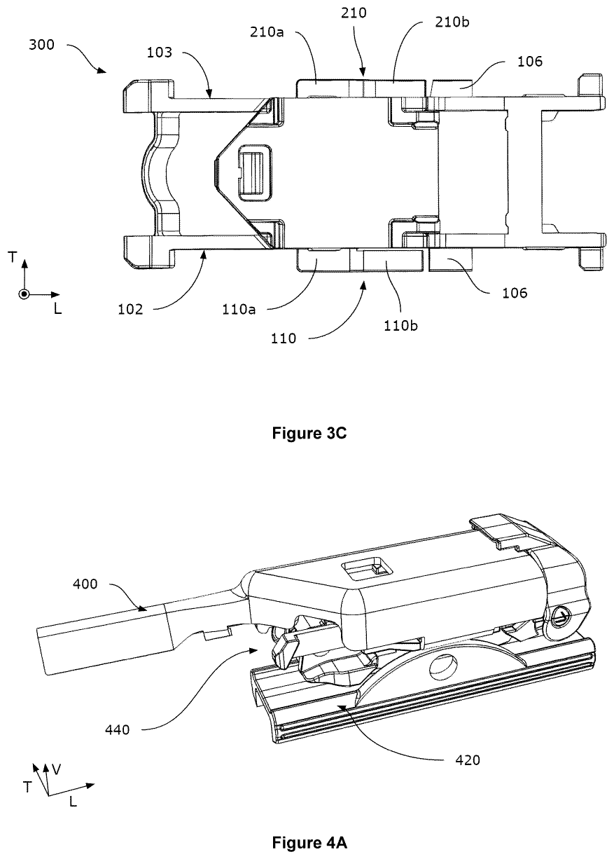

FIGS. 3A, 3B, and 3C show some of the possible variations of a spacer 300. As shown in FIG. 3A, the spacer 300 may include the flexible tab 110 of first embodiment along with the bearing tab 106, provided on both the first longitudinal wall 102 and the second longitudinal wall 103. Preferably, the spacer 300 may be symmetrical about central axis X-X of the spacer 300, as shown in FIG. 3A. FIG. 3B shows an alternate embodiment of the spacer 300, wherein the spacer 300 may include the flexible tab 210 with the tooth 211a, according to second embodiment along with the bearing tab 106, provided on both the first longitudinal wall 102 and the second longitudinal wall 103. Preferably, the spacer 300 may be symmetrical about central axis X-X of the spacer 300, as shown in FIG. 3B. FIG. 3C shows yet another alternate embodiment of the spacer 300, wherein the spacer 300 may include the flexible tab 110 of first embodiment provided on the first longitudinal wall 102 and the flexible tab 210 of second embodiment, provided on the second longitudinal wall 103. Alternatively, the spacer 300 may include the flexible tab 110 of first embodiment, provided on the second longitudinal wall 103 and the flexible tab 210 of second embodiment, provided on the first longitudinal wall 102. It is to be noted that other constructional features of the spacer 300 may be similar to the spacer 100 as disclosed in the first embodiment.

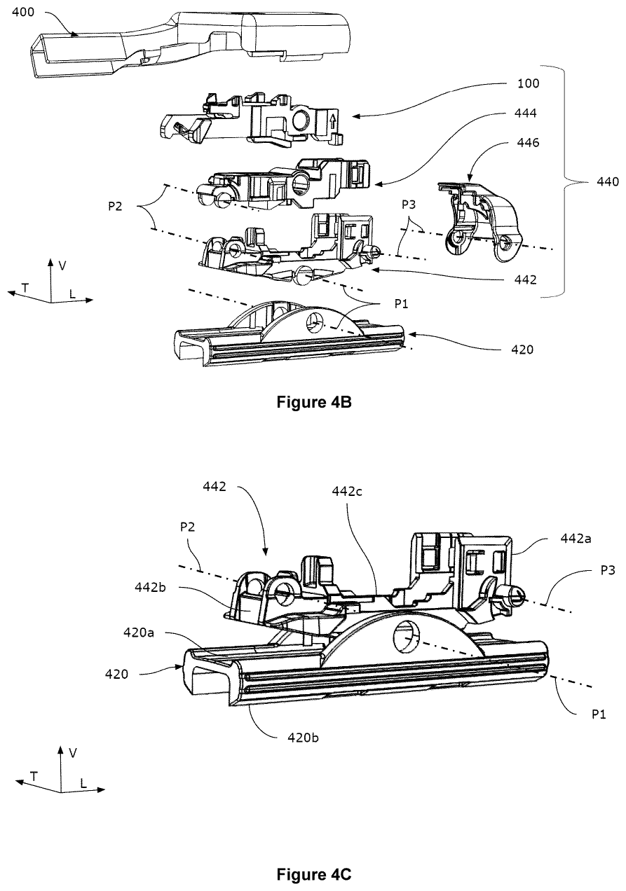

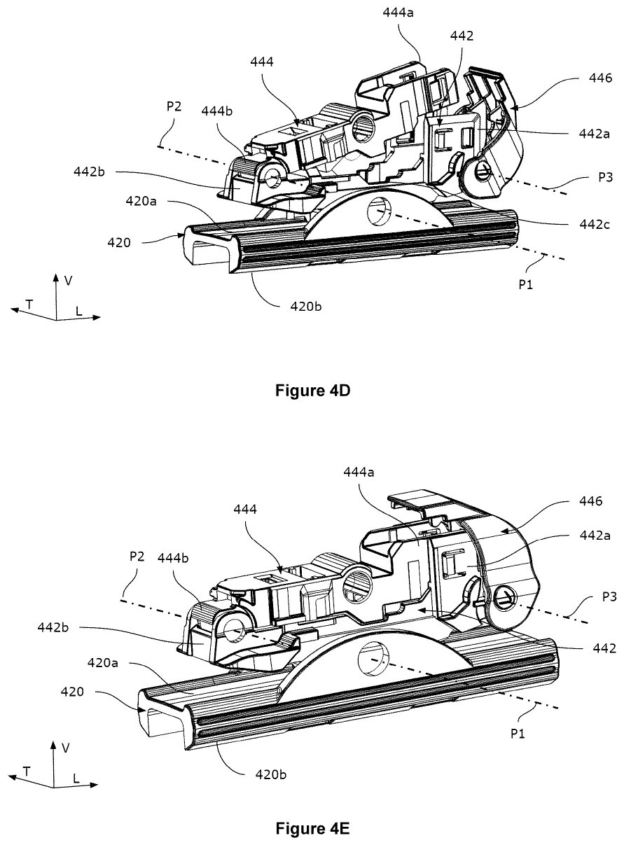

FIG. 4A illustrates a wiper system including a wiper arm 400 connected to a connector 420 of a wiper blade (not shown) through an adapter assembly 440. The connector 420 may be fixedly connected to a structure of the wiper blade. FIG. 4B illustrates an exploded view of the wiper system of FIG. 4A. As can be seen in FIG. 4B, the adapter assembly 440 may include a base member 442, a tilting member 444, the spacer 100 and a locking cap 446. It is to be understood that FIG. 4B shows only exemplary wiper system including adapter assembly 440 having the spacer 100 of the first embodiment. However, the adapter assembly 440 may include the spacer 200, 300 according to other embodiments.

As shown in FIG. 4C, the connector 420 may include an upper side 420a and a lower side 420b opposite to the upper side 420a. In particular, the lower side 420b may be designed to carry the structure of the wiper blade. The adapter assembly 440 may be located on the upper side 420a of the connector 420. The adapter assembly 440 may be pivotally connected to the connector 420, thereby allowing the wiper blade to pivot at one of the ends of the wiper arm 400 to ensure that the wiper blade is pressed against the glass surface to be wiped. More particularly, as shown in FIGS. 4C and 4D, the base member 442 of the adapter assembly 440 may be pivotally mounted on the connector 420, about a first pivot axis P1. The base member 442 may extend longitudinally along the axis L and may include a front end 442a and a rear end 442b arranged on either sides of the first pivot axis P1. The adapter assembly 440 may further include a tilting member 444 placed on a top side 442c of the base member 442. The tilting member 444 may extend longitudinally along the axis L and may include a front end 444a and a rear end 444b. As shown in FIG. 4D, the rear end 444b of the tilting member 444 may be pivotally connected to the rear end 442b of the base member 442, so that the tilting member 444 may pivot about a second pivot axis P2 with respect to the base member 442. The second pivot axis P2 may be arranged, in particular, on a rear part of the base member 442 with respect to the first pivot axis P1. The tilting member 444 may thus be moved by rotation about the second pivot axis P2, between a first position shown in FIG. 4E and a second position shown in FIG. 4D. In first position, the tilting member 444 is folded back against the top side 442c of the base member 442. In second position, the front end 444a of the tilting member 444 may be raised relative to the base member 442. This second position of the tilting member 444 enables certain types of windscreen wiper arms, particularly wiper arms having folded edges, to be mounted on the adapter assembly 440.

The first pivot axis P1 and the second pivot axis P2 may be offset vertically with respect to each other.

In FIGS. 4D and 4E, the adapter assembly 440 may also include a locking cap 446 disposed in front of the base member 442. The locking cap 446 may be pivotally mounted about a third pivot axis P3 with the base member 442. This third pivot axis P3 may be disposed on the front end 442a of the base member 442. The locking cap 446 and third pivot axis P3 are thus arranged at a longitudinal end of the base member 442 which is opposite to the longitudinal end where the second pivot axis P2 is arranged.

In particular, the locking cap 446 may be rotated about the third pivot axis P3 between a locked position shown in FIG. 4E and an unlocked position shown in FIG. 4D. In its locked position, the locking cap 446 covers the front end 442a of the base member 442 and the front end 444a of the tilting member 444, locking said tilting member 444 in its first position and fixing the wiper arm 400 to the adapter assembly 440. In its unlocked position, the locking cap 446 may be tilted forward, releasing the tilting member 444 and allowing the tilting member 444 to tilt into its second position, thereby allowing wiper arm 400 to be mounted on the adapter assembly 440.

The locking cap 446 may include fastening means to lock the locking cap 446 on the base member 442. The fastening means may include projections or pins provided on the locking cap 446 that may be received in corresponding slots provided on the base member 442.

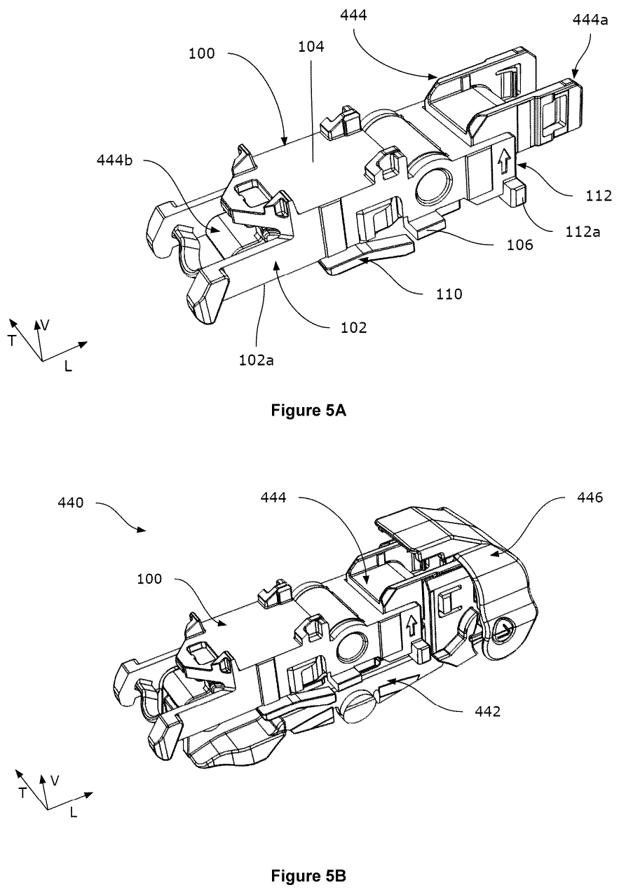

FIG. 5A shows the spacer 100 mounted on the tilting member 444. The spacer 100 may be arranged on a top wall 444c of the tilting member 444 and secured to tilting member 444 by the securing means 115 (shown in FIG. 1D). Preferably, the spacer 100 may be snap-fitted over the tilting member 444 such that the upper wall 104 of the spacer 100 may be positioned above the top wall 444c of the tilting member 444 and the longitudinal walls 102, 103 of the spacer 100 may be positioned positioned juxtaposed to the side walls of the tilting member 444. The spacer 100 allows cooperation between the adapter assembly 440 and wiper arm 400 which cannot be fixed directly to the tilting member 444. FIG. 5B shows the adapter assembly 440, wherein the spacer 100 is secured to the tilting member 444, and the tilting member 444 is folded back against the top side 442c of the base member 442, and the locking cap 446 is in locked position. It is to be understood that, in the adapter assembly 440, the spacer 100 of first embodiment may be replaced with the spacer 200, 300 of other embodiments.

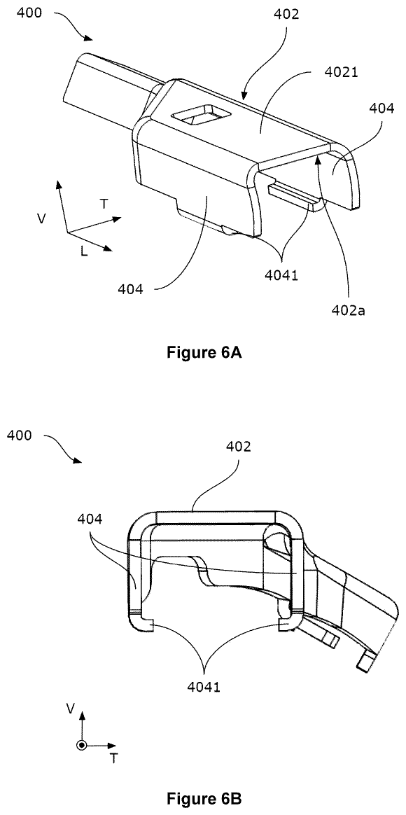

FIGS. 6A and 6B illustrate the wiper arm 400 including a yoke 402 formed at one end. The yoke 402 may generally be U-shaped, with a top wall 4021 connecting two side walls 404. The front end 402a of the yoke 402 may be open so that the yoke 402 may be slid onto the adapter assembly 440 from the rear side of the adapter assembly 440. At their lower end, i.e. opposite the top wall 4021, the side walls 404 of the yoke 402 may have folded edges 4041 designed to cooperate with the flexible tab 110, 210 and/or the bearing tabs 106, 107. The top wall 4021 of the yoke 402 may be designed to rest on the studs 108 of the spacer 100, 200, 300.

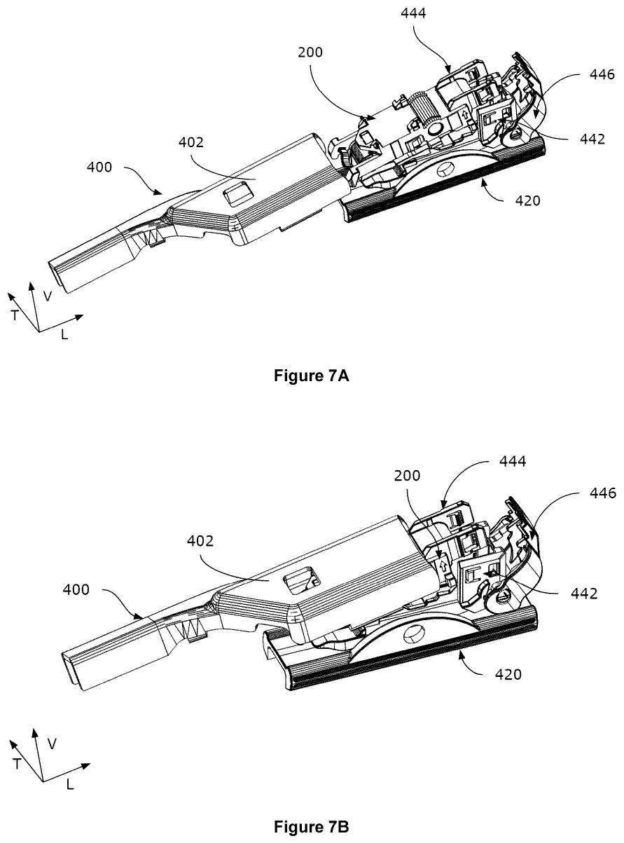

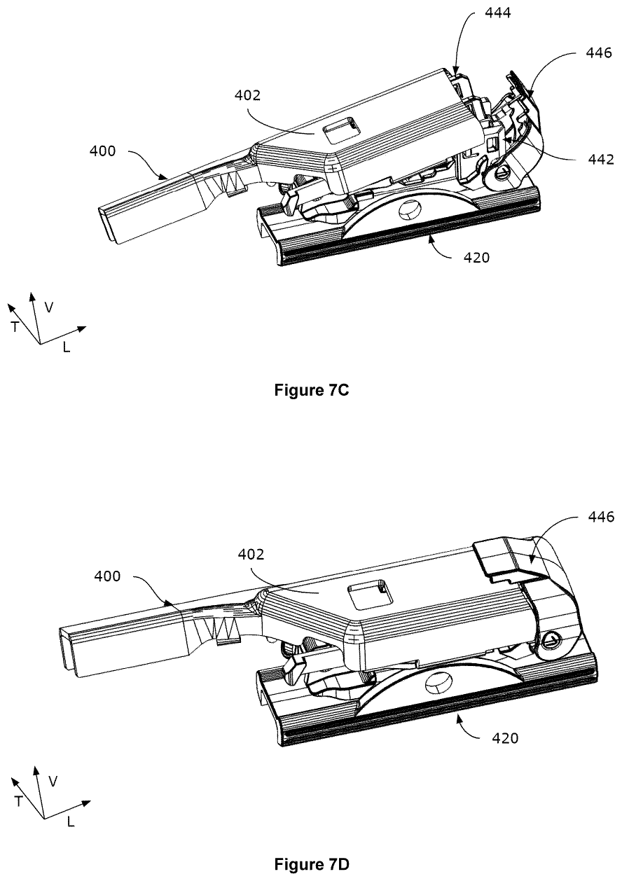

FIGS. 7A, &B, 7C, and 7D illustrate steps of attaching the wiper arm 400 to the adapter assembly 440. In first step, as shown in FIG. 7A, the locking cap 442 is pivoted to the unlocked position and the tilting member 444 along with the spacer 200 may be tilted upwards. The yoke 402 of the wiper arm 400 may be positioned with respect to the adapter assembly 440 such that the front end 402a is facing towards the rear end 444b of the tilting member 444. In second step, as shown in FIG. 7B, the yoke 402 of the wiper arm 400 is slid over the spacer 200 of the adapter assembly 440 such that the folded edges 4041 of the yoke 402 deforms the flexible tab 210 of the spacer 200. The wiper arm 400 may be slid over the spacer 200 till the front end 402a of the yoke 402 is positioned above the front end 444a of the tilting member 444, and the flexible tab 210 comes back to the neutral position, as shown in FIG. 7C. In this state the yoke 402 is secured over the spacer 200. Now the tilting member 444 is pivoted to achieve its folded back position against the top side 442c of the base member 442, as shown in FIG. 7D, and the locking cap 446 is rotated and locked to the base member 442. The locking cap 446 prevents the rotation of the tilting member 444 and of the wiper arm 400 in upward direction, when the locking cap 446 is in locked state as shown in FIG. 7D.

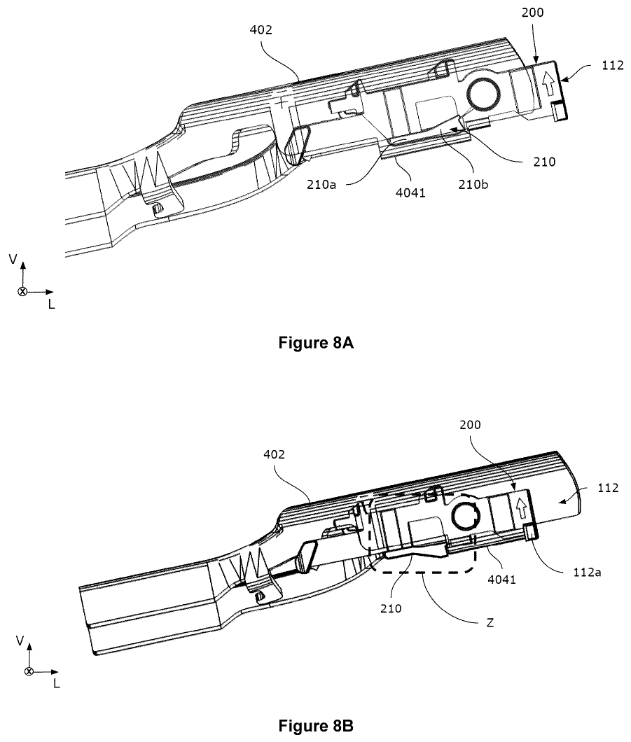

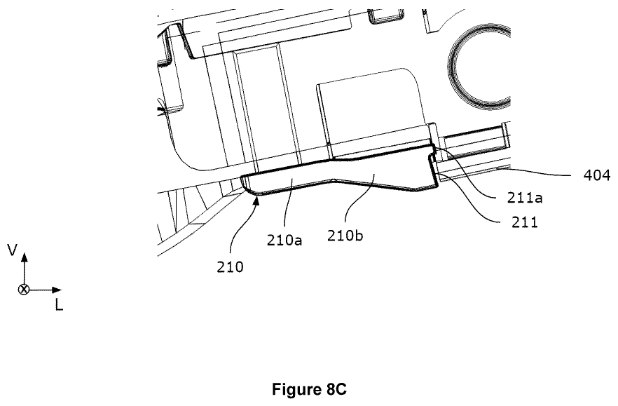

FIGS. 8A, 8B, and 8C show intermediate stages of sliding the yoke 402 over the spacer 200. It is to be noted that other components of the wiper system are hidden and the yoke 402 is made transparent for better understanding of the FIGS. 8A and 8B. When the yoke 402 is slide over the spacer 200, at least one of the folded edges 4041 slides below the flexible tab 210, thereby deforming the deformable portion 210b in upward direction. Upon complete insertion of the yoke 402, the front side of the folded edges 4041 cooperates with the stoppers 112a, 113a formed on the longitudinal walls 102, 103, to restrict further forward movement of the yoke 402. Moreover, the deformable portion 210b of the flexible tab 210 regains the neutral/un-deformed state and the abutting face 211 cooperates with the rear end of at least one of the folded edges 4041 to restrict rearward movement of the yoke 402 with respect to the spacer 200. The tooth 211a provided on the abutting face 211 prevents the deformation of the deformable portion 210b in downward direction, thereby reducing the failure of the flexible tab 210 in a situation where the yoke 402 tries to move rearwards with a considerable force.

While removing the wiper arm 400 from the adapter assembly 440, first the locking cap 446 may be pivoted to its unlocked position, then the tilting member 444 may be pivoted to raise the front end 444a. Further, the deformable portion 210b may be pushed upwards and the yoke 402 may be slid rearwards.

It is to be noted that although the FIGS. 7A to 8C are described with the adapter assembly having the spacer 200 of the second embodiment, the same can be envisaged with the spacer 100, 300 of other embodiments.

It is to be understood that the spacers 100, 200, 300 are also compatible with the wiper arm 400 having folded edges 4041 longer than that of the wiper arm 400, i.e. length of the folded edges being more than the distance between the free end of the flexible tab 110, 210 and the stopper 112a, 113a when the flexible tab is in deformed state. In this case, the deformable portion 110b, 210b of the flexible tab 110, 210 stay deformed after complete insertion of the yoke of the wiper arm over the spacer 100, 200, 300. For restricting rearward movement of the wiper arm with respect to the adapter assembly 440, restricting features may be provided on the base member 442.

The invention shall not, however, be limited to the means and configurations described and illustrated herein, and shall also extend to any equivalent means or configuration described and illustrated herein, and to any technical combination operating such means.

LIST OF REFERENCE SIGNS

| | |
|---|---|
| 100, 200, 300 | Spacer |
| 102 | First longitudinal wall |
| 103 | Second longitudinal wall |
| 102a, 103a | Lower face |
| 1021, 1031 | Tongue |
| 1022, 1032 | Stop |
| 1023 | Cross-member |
| 104 | Upper wall |
| 104a, 104b | Portions of upper wall |
| 106, 107 | Bearing tab |
| 108 | Stud |
| 110, 210 | Flexible tab |
| 110a, 210a | Fixed portion |
| 110b, 210b | Deformable portion |
| 111, 211 | Abutting face |
| 211a | Tooth |
| 112 | First longitudinal end |
| 113 | Second longitudinal end |
| 112a, 113a | Stopper |
| 114 | Hook |
| 115 | Securing means |
| 116, 117 | Locking tab |
| 400 | Wiper Arm |
| 402 | Yoke |
| 402a | Front end of yoke |
| 4021 | Top wall of yoke |
| 404 | Side wall of yoke |
| 4041 | Folded edge |
| 420 | Connector |
| 420a | Upper side |
| 420b | Lower side |
| 440 | Adapter assembly |
| 442 | Base member |
| 442a | Front end of base member |
| 442b | Rear end of base member |
| 442c | Top side of the base member |
| 444 | Tilting member |
| 444a | Front end of tilting member |
| 444b | Rear end of tilting member |
| 444c | Top wall of tilting member |
| 446 | Locking cap |
| P1, P2, P3 | Pivot axis |

What is claimed is:

1. A spacer for an adapter assembly of a wiper system, the spacer comprising:
a first longitudinal wall;
a second longitudinal wall spaced apart from the first longitudinal wall, the first longitudinal wall and the second longitudinal wall being connected to each other by an upper wall; and
a flexible tab formed near a lower face of at least one of the first longitudinal wall and the second longitudinal wall, the flexible tab including at least a deformable portion.

2. The spacer according to claim 1, wherein the flexible tab includes a fixed portion protruding outwards from at least one of the first longitudinal wall and the second longitudinal wall.

3. The spacer according to claim 2, wherein the deformable portion longitudinally extends from the fixed portion, the deformable portion being inclined away from the upper wall, in neutral state, and the deformable portion being configured to deform towards the upper wall.

4. The spacer according to claim 1, further comprising a bearing tab formed near the lower face of at least one of the first longitudinal wall and the second longitudinal wall.

5. The spacer according to claim 1, further comprising a stopper formed near at least one of a first longitudinal end of the first longitudinal wall and a second longitudinal end of the second longitudinal wall.

6. The spacer according to claim 1, further comprising a securing means including a locking tab formed on an inner surface of at least one of the first longitudinal wall and the second longitudinal wall, and a hook projecting from the upper wall.

7. The spacer according to claim 1, wherein the flexible tab includes a tooth formed on an abutting face of the deformable portion.

8. The spacer according to claim 1, further comprising at least one stud formed on the upper wall.

9. An adapter assembly for a wiper system, the adapter assembly comprising:
a base member having a front end and a rear end;
a tilting member pivotally connected to the rear end of the base member;
a locking cap pivotally connected to the front end of the base member; and
a spacer configured to be removably secured to the tilting member,
wherein the spacer includes two longitudinal walls spaced apart from each other and connected to each other by an upper wall, and a flexible tab formed near a lower face of at least one of the longitudinal walls, the flexible tab includes at least a deformable portion.

10. The adapter assembly according to claim 9, wherein the base member is configured to be pivotally connected to a connector of a wiper blade.

11. The adapter assembly according to claim 9, wherein the tilting member includes two side walls connected to each other by a top wall.

12. The adapter assembly according to claim 11, wherein the spacer is snap-fitted over the tilting member, the upper wall of the spacer being positioned above the top wall of the tilting member and the longitudinal walls of the spacer being positioned juxtaposed to the side walls of the tilting member.

13. The adapter assembly according to claim 9, wherein the spacer further includes a securing means to secure the spacer to the tilting member.

14. The adapter assembly according to claim 13, wherein the securing means include a locking tab formed on an inner surface of at least one of the longitudinal walls, and a hook projecting from the upper wall of the spacer.

15. The adapter assembly according to claim 9, wherein the flexible tab includes a fixed portion protruding outwards from at least one of the longitudinal walls.

16. The adapter assembly according to claim 15, wherein the deformable portion longitudinally extends from the fixed portion, the deformable portion being inclined away from the upper wall, in neutral state, and the deformable portion being configured to deform towards the upper wall.

17. The adapter assembly according to claim 16, wherein the flexible tab includes an abutting face at a free end of the deformable portion, the abutting face being configured to cooperate with a folded edge of a wiper arm.

18. The adapter assembly according to claim 17, wherein the flexible tab includes a tooth formed on the abutting face, the tooth configured to cooperate with the folded edge of the wiper arm to restrict the deformation of the deformable portion in a direction away from the upper wall.

19. The adapter assembly according to claim 9, wherein the spacer further includes at least one stud formed on the upper wall.

20. A wiper system for a motor vehicle, the wiper system comprising:
a connector configured to be attached to a wiper blade;
an adapter assembly configured to be pivotally connected to the connector; and
a wiper arm configured to be releasably connected and secured to the adapter assembly, wherein the wiper arm includes a yoke having folded edges, configured to slide over the adapter assembly, and
wherein the adapter assembly includes a spacer having two longitudinal walls spaced apart from each other and connected to each other by an upper wall, and a flexible tab formed near a lower face of at least one of the longitudinal walls, the flexible tab includes at least a deformable portion, and
wherein the flexible tab allows the yoke of the wiper arm to slide over the spacer by deforming in a direction towards the upper wall.
